(19) United States
(12) Patent Application Publication
(10) Pub. No.: US 2016/0381253 A1
(43) Pub. Date: Dec. 29, 2016

(54) IMAGE PROCESSOR COMPRISING LOCAL COLOR PROCESSING CIRCUITS AND ASSOCIATED IMAGE PROCESSING METHOD FOR ADJUSTING BLUE LIGHT STRENGTH OF IMAGE

(71) Applicant: MEDIATEK INC., Hsin-Chu (TW)

(72) Inventors: Shao-Yang Wang, Taichung City (TW); Yu-Ju Lin, Hsinchu City (TW); Ying-Jui Chen, Hsinchu County (TW); Keh-Tsong Li, Kaohsiung City (TW); Shang-Hsiu Wu, Hsinchu County (TW); Te-Hao Chang, Taipei City (TW)

(21) Appl. No.: 15/176,133

(22) Filed: Jun. 7, 2016

Related U.S. Application Data
(60) Provisional application No. 62/184,889, filed on Jun. 26, 2015.

(51) Int. Cl. H04N 1/60; G09G 5/02

(52) U.S. Cl. CPC H04N 1/6027; G09G 5/02

(57) ABSTRACT

An image processing method performed by an image processor includes: receiving an image, wherein the image comprises a plurality of pixels having different strengths of at least one color; unevenly adjusting the strengths of the at least one color of specific pixels to generate a processed image.

### CROSS REFERENCE TO RELATED APPLICATIONS

This application claims the priority of U.S. Provisional Application No. 62/184,889, filed on Jun. 26, 2015, which is included herein by reference in its entirety.

### BACKGROUND

Because a blue light is generally understood to be harmful to the eye, and is possibly leading to cataracts and other eye diseases such as macular degeneration, therefore, a display may have a mechanism to lower the blue light for the better eye care. However, the blue light reduction operation may seriously influence the image quality, for example, the skin/complexion may be reddish, the sky may be grayed . . . etc. Therefore, how to provide an image processing method which can lower the blue light while maintaining the image quality is an important topic.

### SUMMARY

It is therefore an objective of the present invention to provide an image processing method an associated image processing apparatus to solve the above-mentioned problem.

According to one embodiment of the present invention, an image processing method performed by an image processor comprises: receiving an image, wherein the image comprises a plurality of pixels having different strengths of at least one color; unevenly adjusting the strengths of the at least one color of specific pixels to generate a processed image.

According to one embodiment of the present invention, an image processing method performed by an image processor comprises: performing a global color processing operation upon an image to adjust colors of the entire image; and performing a local color processing operation upon specific pixels of the image to adjust colors of the specific pixels, but not performing the local color processing operation upon the other pixels of the image, wherein the specific pixels have at least one color or at least one color range.

According to one embodiment of the present invention, an image processor comprises a global color processing circuit and a local color processing circuit. The global color processing circuit is arranged for performing a global color processing operation upon an image to adjust colors of the entire image. The local color processing circuit is arranged for performing a local color processing operation upon specific pixels of the image to adjust colors of the specific pixels, but not performing the local color processing operation upon the other pixels of the image, wherein the specific pixels have at least one color or at least one color range.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to one embodiment of the present invention.

FIG. 2 is a flowchart of an image processing method according to one embodiment of the present invention.

FIG. 3 is a flowchart of an image processing method according to another embodiment of the present invention.

FIG. 4 is a flowchart of an image processing method according to another embodiment of the present invention.

FIG. 5 is a diagram illustrating a plurality of image processors according to one embodiment of the present invention.

FIG. 6 shows a local-color-processed image according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

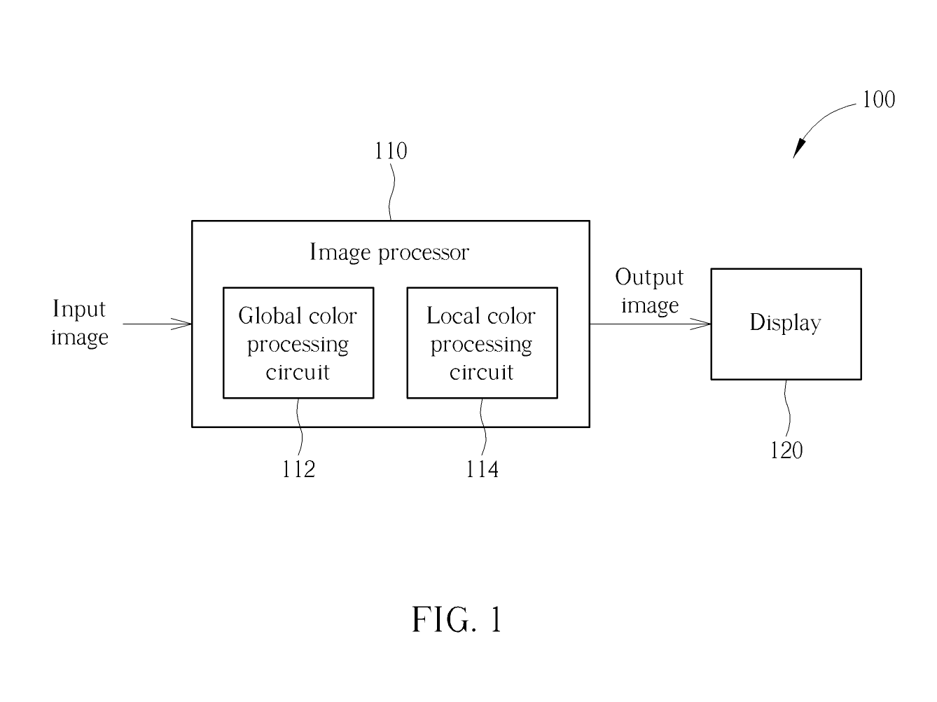

Please refer to FIG. 1, which is a diagram illustrating an electronic device 100 according to one embodiment of the present invention. As shown in FIG. 1, the electronic device 100 comprises at least one image processor 110 and a display 120, where the image processor 110 comprises at least one a global color processing circuit 112 and a local color processing circuit 114. In this embodiment, the electronic device 100 can be a cell phone, a tablet, a notebook, a digital camera or any other electronic device having a display panel.

In this embodiment, image processor 110 is used to adjust colors of an input image to generate an output image to the display 120. Within the image processor 110, the global color processing circuit 112 is arranged to perform a global color processing operation upon an image to adjust colors of the entire image. The local color processing circuit 114 is arranged to perform a local color processing operation upon specific pixels of the image to adjust colors of the specific pixels without affecting other pixels, thus no performing the local color processing operation upon the other pixels or all pixels of the image, wherein the specific pixels have at least one color or at least one color range being defined. It is noted that the executing sequence of the global color processing circuit 112 and the local color processing circuit 114 is not a limitation of the present invention. Thus, in one embodiment, the image may be performed by the global color processing circuit 112 first. In another embodiment, the image may be performed by the local color processing circuit 114 first. Detailed descriptions of the global color processing circuit 112 and the local color processing circuit 114 are as follows.

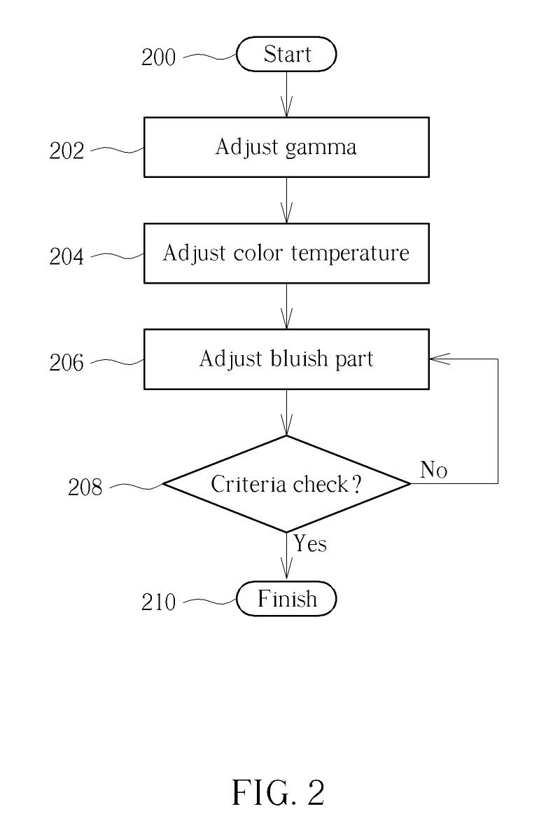

FIG. 2 is a flowchart of an image processing method according to one embodiment of the present invention. As shown in FIG. 2, in Step 200, the flow starts. In Step 202, the global color processing circuit 112 receives the image and uses a gamma table to adjust a gamma value of the entire image to meet a designed value, for example gamma=2.2. Then, in Step 204, the global color processing circuit 112 uses one or more color matrixes (e.g. 3*3 color matrix) to lower a color temperature (CT) of the image to meet a designed CT, for example CT=5000K. In Steps 202 and 204 performed by the global color processing circuit 112, the blue light of the white pattern can be reduced about 50%.

In addition, in Step 206, the local color processing circuit 114 receives the global-color-processed image outputted by the global color processing circuit 112, and performs a local color processing operation upon specific pixels of the global-color-processed image to adjust colors of the specific pixels having at least one (defined) color, but not adjust colors of the other pixels. In one embodiment, in order to lower the blue light without influencing other colors, the local color processing circuit 114 merely adjusts a pure blue part of the global-color-processed image to lower strength of blue color. For example, the pixels whose (R, G, B)=(0, 0, >128) can be selected as the specific pixels, and the local color processing circuit 114 can lower the blue color ingredient by using a designed ratio or by lowering the blue color directly to be “128” (i.e. the adjusted color (R, G, B)=(0, 0, 128)). By using the Step 206 performed by the local color processing circuit 114, the blue light of the bluish pattern can be reduced more about 25%.

In Step 208, the local color processing circuit 114 checks whether the processed image satisfies the required criteria, for example, whether the blue light is low enough or not. If yes, the flow enter Step 210 to finish the flow and the local color processing circuit 114 outputs the processed image to the following circuit modules; if not, the flow goes back to Step 206 to re-adjust the image.

In the embodiment shown in FIG. 2, because the global color processing circuit 112 just lower the blue light at a middle level (e.g. CT=5000K), the other colors will not be serious influenced, that is the skin color will not become too reddish. In addition, by further using the local color processing circuit 114 to lower the strength the blue light of the blue pattern (or pure blue pattern) without adjusting other colors, the blue light can be reduced more for the eye care. In light of above, the embodiment shown in FIG. 2 can effective lower the blue light while maintaining the image quality.

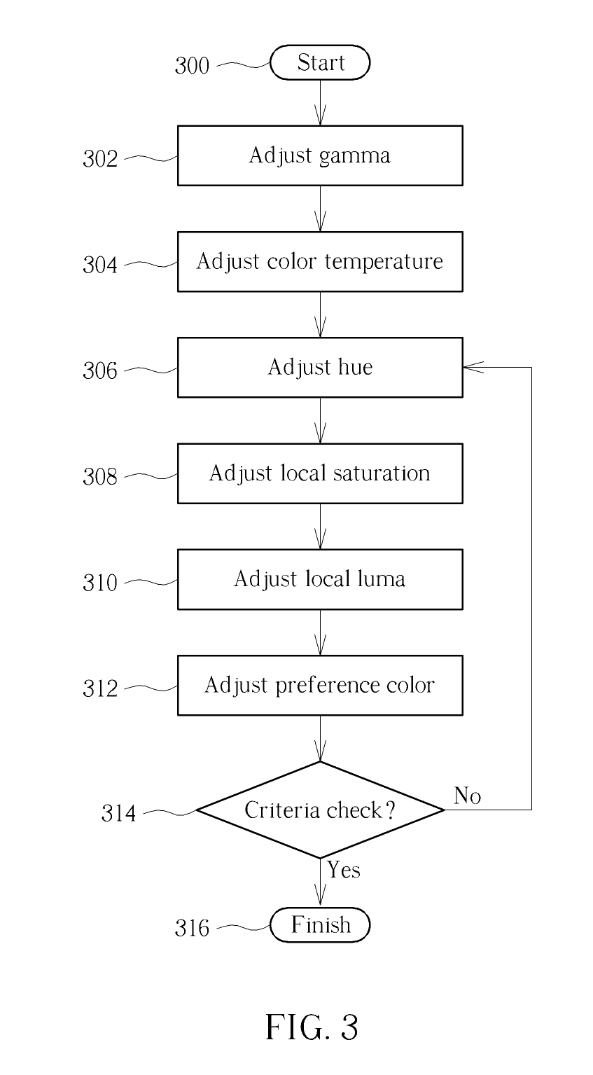

FIG. 3 is a flowchart of an image processing method according to another embodiment of the present invention. As shown in FIG. 3, in Step 300, the flow starts. In Step 302, the global color processing circuit 112 receives the image and uses a gamma table to adjust a gamma value of the entire image to meet a designed value, for example gamma=2.2. Then, in Step 304, the global color processing circuit 112 uses one or more color matrixes to lower a color temperature (CT) of the image to meet a designed CT, for example CT=4100K. Then, in Step 306, the data of the image is transformed to a HSV (Hue, Saturation, Value) color space, and the global color processing circuit 112 adjusts the hue of the image to lower the blue light and compensate other colors of the image. In Steps 302, 304 and 306 performed by the global color processing circuit 112, the blue light of the white pattern can be reduced about 70%.

Compared with the embodiment shown in FIG. 2, in this embodiment the global color processing circuit 112 lower the blue light with weakening a stronger level (e.g. to be CT=4100K), therefore, the colors may be different from the origin, that is the skin/complexion may be reddish and the sky/grass may be grayed. To compensate this image quality degradation, the following steps performed by the local color processing circuit 114 are arranged to adjust the saturation (Step 308), luma (Step 310) and preference color (Step 312) for specific pixels having at least one defined color or at least one defined color range, but not adjust colors of the other pixels. In one embodiment, the pixels whose colors belong to skin/complexion color (e.g. by referring to data in RGB, HSV or YUV color space) are selected as the specific pixels, and the local color processing circuit 114 can reduce a red component of the specific pixels by adjusting some components of the RGB, HSV or YUV color space (e.g. saturation adjustment in Step 308 and adjustment luma in Step 310). In addition, to improve the skin/complexion color, the local color processing circuit 114 can also decrease the skin color saturation and/or increase the strength/luminance of yellow color. In another embodiment, the pixels whose colors belong to sky color or grass color (e.g. by referring to data in RGB, HSV or YUV color space) are selected as the specific pixels, and the local color processing circuit 114 can enhance the sky color or the grass color of the specific pixels.

In Step 314, the local color processing circuit 114 checks whether the processed image satisfies the required criteria, for example, whether the blue light is low enough or not, or whether the skin/complexion color is not too reddish. If yes, the flow enter Step 316 to finish the flow and the local color processing circuit 114 outputs the processed image to the following circuit modules; if not, the flow goes back to Step 306 to re-adjust the image.

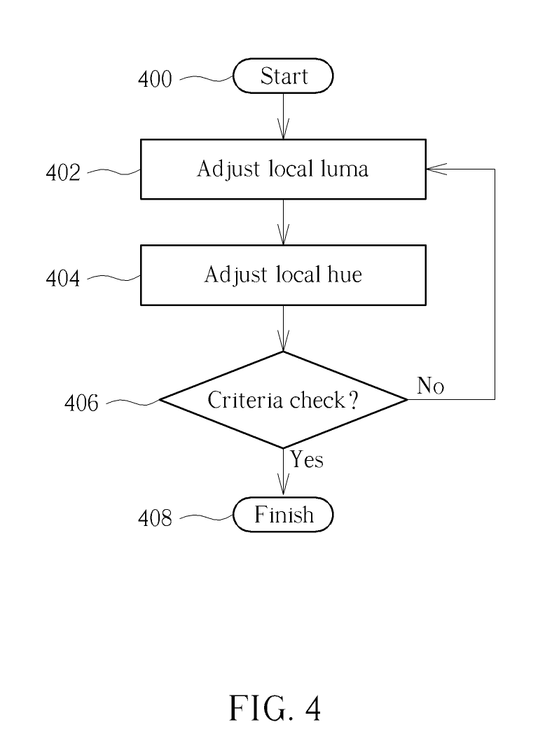

FIG. 4 is a flowchart of an image processing method according to another embodiment of the present invention. As shown in FIG. 4, in Step 400, the flow starts. In Step 402, pixel data of the images is in YUV color space, and the local color processing circuit 114 reduces the luminance of the specific pixels which contain higher blue light, but the local color processing circuit 114 does not adjust other pixels of the image. For example, the pixels having higher blue light are selected as the specific pixels, and the local color processing circuit 114 reduces the luminance (Y) of the specific pixels to lower the strength of the blue light. In addition, for the pixels not having higher blue light, the local color processing circuit 114 does not adjust their luminance.

In step 404, pixel data of the images is in HSV color space, the local color processing circuit 114 shifts the color of the specific pixels which contain higher blue light. For example, the pixels having higher blue light are selected as the specific pixels, and the local color processing circuit 114 changes the hue of the specific pixels to lower the strength of the blue light. In addition, for the pixels not having higher blue light, the local color processing circuit 114 does not adjust their hue.

In Step 406, the local color processing circuit 114 checks whether the processed image satisfies the required criteria, for example, whether the blue light is low enough or not, or whether the skin/complexion color is not too reddish. If yes, the flow enter Step 408 to finish the flow and the local color processing circuit 114 outputs the processed image to the following circuit modules; if not, the flow goes back to Step 402 to re-adjust the image.

The embodiment shown in FIG. 4 merely uses the local color processing circuit 114 to adjust colors of the specific pixels having higher blue light, and the other pixels are not adjusted. Therefore, the colors of the other pixels may not be influenced, and the image quality can be maintained while lowering the blue light.

It is noted that one or more steps shown in FIGS. 2-4 can be combined together to lower the blue color of the pixels by using different methods and/or to compensate skin/complexion color, sky color or green color of the other pixels. Moreover, the colors to be compensated are not limited in the colors of sky, sea, grass leaf, skin, etc. Generally speaking, the colors for people with familiar impressions can be selected to be compensated. The embodiment shown in FIG. 1 can be modified to have more image processors each having global color processing circuit and/or local color processing circuit. These alternative designs shall fall within the scope of the present invention.

In addition, the executing sequence of the steps shown in FIGS. 2-4 are for illustrative purposes only, and are not limitations of the present invention. In other embodiments, the steps performed by the local color processing circuit 114 can be before the steps performed by the global color processing circuit 112. In detail, the local color processing circuit 114 may perform the local color processing operation upon the image to generate local-color-processed image, then the global color processing circuit 112 performs the global color processing operation upon the local-color-processed image to generate the output image. This alternative design shall fall within the scope of the present invention.

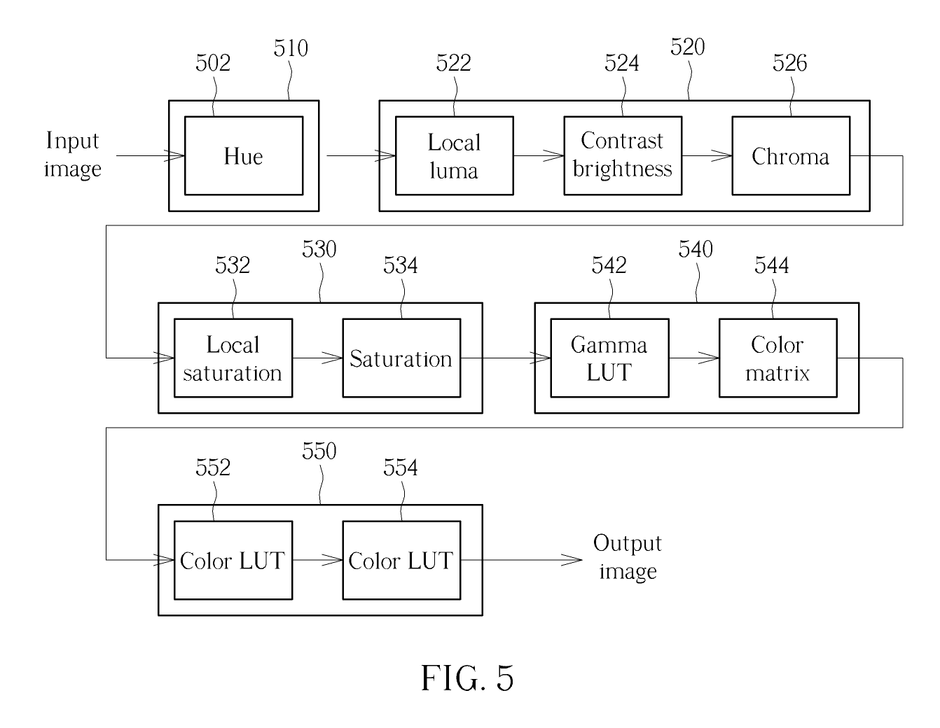

FIG. 5 is a diagram illustrating a plurality of image processors 510, 520, 530, 540 and 550 according to one embodiment of the present invention, where each image processor comprises at least one circuit module to adjust the color of the pixels. In detail, the image processor 510 comprises a circuit module 502 to adjust the hue of the entire image; the image processor 520 comprises circuit modules 522, 524 and 526 to adjust the local luma, contrast brightness and chroma, respectively, where the circuit module 522 can be local color processing circuit, and circuit modules 524 and 526 can be global color processing circuit; the image processor 530 comprises circuit modules 532 and 534 to adjust the local saturation and saturation, respectively, where the circuit module 532 can be local color processing circuit, and circuit module 534 can be global color processing circuit; the image processor 540 comprises circuit modules 542 and 544 for gamma look-up table (LUT) and color matrix, respectively; and the image processor 550 comprises circuit modules 552 and 554 both for color LUT.

In another embodiment, the image processor 110 may refer to a timing recorded in the electronic device 100 to determine an adjusting level, and uses the adjusting level to adjust the colors of the specific pixels such as the Steps 206, 308-312 or 402-404. In one embodiment, to provide better eye care for the user when the user watches the electronic device 100 over a period of time, the longer the using time of the electronic device, the greater the blue color reduction level performed by the image processor 110. In another embodiment, the global color processing circuit 112 and/or the local color processing circuit 114 perform the global/local color processing operation upon the specific pixels of the image to use a first adjust level to reduce a strength of blue color of the specific pixels when it is in the morning, and the global color processing circuit 112 and/or the local color processing circuit 114 perform the global/local color processing operation upon the specific pixels of the image to use a second adjust level to reduce the strength of blue color of the specific pixels when it is in the evening, wherein the first adjust level is weaker than the second adjust level.

In another embodiment, the image processor 110 may refer to ambient information of the electronic device 100 to determine an adjusting level, and uses the adjusting level to adjust the colors of the specific pixels such as the Steps 206, 308-312 or 402-404. The ambient information could be ambient luminance or surrounding light color (such as color temperature, hue, saturation, intensity or chromaticity . . . etc) or surrounding light type (such as halogen, fluorescent, tungsten, sunrise, sunset, rainy, cloudy . . . etc) around the electronic device 100. In one embodiment, to provide better eye care for the user when the user watches the electronic device 100 under a low light environment, the darker of the environment, the greater the blue color reduction level performed by the image processor 110. In another embodiment, to provide better eye care with better reading experience for the user, the image processor 110 determine an adjusting level to adjust the colors of the specific pixels according to the surrounding light color, such as the Steps 206, 308-312 or 402-404.

It is noted that the output image to the display 120 is concrete and visible, but the processed images mentioned (such as global-color-processed image and local-color-processed image) are not concrete and visible, they are for the purpose of easy description. The processed images (such as global-color-processed image and local-color-processed image) could be seen as pixel data or pixel value to be processed.

Moreover, it is also noted that the pixel mentioned can be primary color pixel (such as Red, Green, Blue or other primary colors defined by specific displays), and the strength adjusting/level adjusting are accordingly operated. Thus, the visible color of specific pixels is showed according to the mixing ratio between the primary colors.

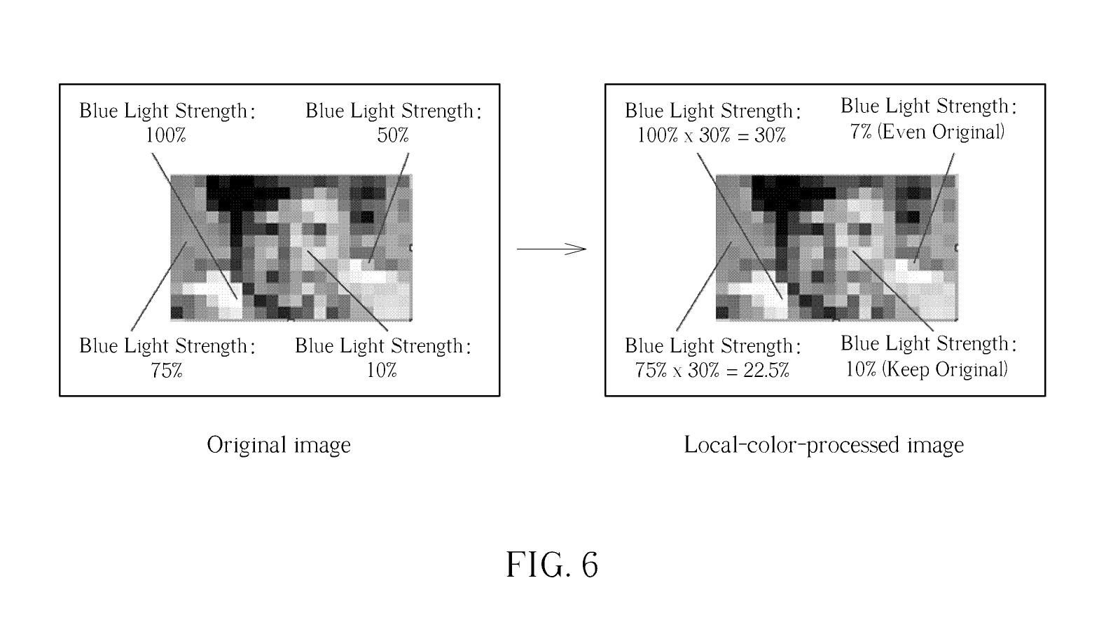

In the above-mentioned embodiments, because of the operations of the local color processing circuit 114, the blue light of the pixels of the image are adjusted unevenly. For example, referring to FIG. 6, if the original image is required to lower the blue light by 70%, different colors may have different blue light reduction level. As shown in FIG. 6, according to the local color processing operation, a pixel having blue light strength 100% maybe reduced to 30%, a pixel having blue light strength 75% may be reduced to 22.5%, a pixel having blue light strength 50% may be reduced to 7%, and a pixel having blue light strength 10% may be not reduced. On the other hand, according to the global color processing operation, if the original image is required to lower the blue light by 70%, the pixels having blue light strength 100%, 75%, 50% and 10% may be reduced to 30%, 22.5%, 15% and 3%, respectively.

Briefly summarized, in the image processing method of the present invention, by using the local color processing circuit or the combination of the global color processing circuit and the local color processing circuit, the image quality can be maintained while the blue light is reduced for the eye care.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing method performed by an image processor, comprising
receiving an image, wherein the image comprises a plurality of pixels having different strengths of at least one color;
unevenly adjusting the strengths of the at least one color of specific pixels to generate a processed image.

2. The image processing method of claim 1, wherein the at least one color is blue.

3. The image processing method of claim 1, further comprising:
referring to ambient information for unevenly adjusting the strengths of the at least one color of the specific pixels.

4. The image processing method of claim 2, wherein the step of unevenly adjusting the strengths of the at least one color of specific pixels to generate the processed image comprises:
performing a local color processing operation upon the specific pixels of the image to unevenly adjust the strengths of the at least one color of specific pixels.

5. The image processing method of claim 4, wherein the step of performing the local color processing operation upon the specific pixels of the image comprises:
performing the local color processing operation upon the specific pixels of the image to lower a strength of blue color of the specific pixels.

6. The image processing method of claim 4, wherein the step of performing the local color processing operation upon the specific pixels of the image comprises:
performing the local color processing operation upon the specific pixels of the image to shift/change colors of the specific pixels.

7. The image processing method of claim 1, further comprising:
adjusting values of a group of pixels of the image having at least one color range, wherein the at least one color range is skin/complexion.

8. The image processing method of claim 7, wherein the step of adjusting the values of the group of pixels comprises:
performing the local color processing operation upon the group of pixels of the image to reduce a red component of the group of pixels.

9. The image processing method of claim 1, further comprising:
adjusting values of a group of pixels of the image having at least one color range, wherein the at least one color range is sky color or grass color.

10. The image processing method of claim 9, wherein the step of adjusting the values of the group of pixels comprises:
performing the local color processing operation upon the group of pixels of the image to enhance the sky color or the grass color of the group of pixels.

11. The image processing method of claim 1, further comprising:
performing a local color processing operation upon the specific pixels of the image to unevenly adjust the strengths of the at least one color of specific pixels; and
performing a global color processing operation upon the image to adjust colors of the entire image.

12. The image processing method of claim 11, wherein the step of performing the global color processing operation upon the image to adjust colors of the entire original image comprises:
using a gamma table to adjust a gamma value of the image, or using a color matrix to adjust a color temperature of the image to perform the global color processing operation upon the image.

13. The image processing method of claim 1, wherein the image processor is positioned in an electronic device having a display, and the image processing method further comprises:
referring to a timing recorded in the electronic device to determine an adjusting level; and
using the adjusting level to adjust colors of the specific pixels.

14. The image processing method of claim 13, wherein the step of using the adjusting level to adjust colors of the specific pixels comprises:
reducing the strengths of blue color of the specific pixels, wherein the longer the using time of the electronic device, the greater the blue color reduction level.

15. The image processing method of claim 13, wherein the step of using the adjusting level to adjust colors of the specific pixels comprises:
using a first adjust level to reduce the strengths of blue color of the specific pixels when it is in the morning; and
using a second adjust level to reduce the strengths of blue color of the specific pixels when it is in the evening;
wherein the first adjust level is weaker than the second adjust level.

16. An image processing method performed by an image processor, comprising
performing a global color processing operation upon an image to adjust colors of the entire image; and
performing a local color processing operation upon specific pixels of the image to adjust colors of the specific pixels, wherein the specific pixels have at least one color or at least one color range.

17. The image processing method of claim 16, wherein the at least one color is blue, and the step of performing the local color processing operation upon the specific pixels to adjust the colors of the specific pixels comprises:
performing the local color processing operation upon the specific pixels to lower a strength of blue color of the specific pixels or to shift/change colors of the specific pixels .

18. The image processing method of claim 16, wherein the at least one color range is skin/complexion, and the step of performing the local color processing operation upon the specific pixels to adjust the colors of the specific pixels comprises:
performing the local color processing operation upon the specific pixels of the image to reduce a red component of the specific pixels.

19. An image processor, comprising:
a global color processing circuit, for performing a global color processing operation upon an image to adjust colors of the entire image; and
a local color processing circuit, for performing a local color processing operation upon specific pixels of the image to adjust colors of the specific pixels, wherein the specific pixels have at least one color or at least one color range.

20. The image processor of claim 19, wherein the at least one color is blue, and the local color processing circuit performs the local color processing operation upon the specific pixels to lower a strength of blue color of the specific pixels or to shift/change colors of the specific pixels .
